(19) United States
(12) Patent Application Publication
(10) Pub. No.: US 2020/0346787 A1
(43) Pub. Date: Nov. 5, 2020

(54) SMART LOCALIZED CONTROL NODE DEVICES AND SYSTEMS FOR ADAPTIVE AVIONICS APPLICATIONS

(71) Applicant: Relativity Space, Inc., Inglewood, CA (US)

(72) Inventors: Bryce SALMI, Los Angeles, CA (US); Brandon PEARCE, Los Angeles, CA (US)

(21) Appl. No.: 16/862,288

(22) Filed: Apr. 29, 2020

Related U.S. Application Data
(60) Provisional application No. 62/841,038, filed on Apr. 30, 2019.

(51) Int. Cl. B64G 1/42; H04L 29/08; B64G 1/00

(52) U.S. Cl. CPC B64G 1/428; B64G 1/002; H04L 67/12

(57) ABSTRACT

Disclosed herein are smart node devices that provide an interface for multiple sensors and/or actuators, and that may be used to create flexible, easily re-configured wire harness systems for avionics applications.

### CROSS-REFERENCE

This application claims the benefit of U.S. Provisional Application No. 62/841,038 filed Apr. 30, 2019, which is herein incorporated by reference in its entirety.

### BACKGROUND

The phrase “avionics” refers to the electronic systems used on aircraft, artificial satellites, launch vehicles, and spacecraft. These systems support a variety of different functions, including communications, navigation, and the display and management of multiple power and data systems fitted to the vehicle to perform distinct flight functions. An important sub-system of the overall control system for these vehicles is the wiring harness used to connect different components of the system. A large portion of avionics wire harnessing and circuitry is dedicated to sensor and actuator support in the form of power and communications delivery.

### SUMMARY

Size, Weight, and Power (SWaP) analysis is traditionally a large factor in optimizing the wire harnessing required to support point-to-point control of sensors and actuators from an avionics box that provides multiple communication channels for each type of sensor or actuator. Often, each sensor or actuator type may require its own circuit board inside an avionics box that includes a large connector interface to provide external access to signals. While SWaP efficiency is maximized, this approach results in the “baking in” of a large number of spare channels to support changes in vehicle design (e.g., changes in a launch vehicle design), and requires completely custom harnessing in most cases. If at any time during development the design changes (especially with the advent of 3D printing and other rapid prototyping and manufacturing tools), such that a harness or circuit board no longer provides the required number of channels, then a new custom circuit or harness is required which can result in many months of delay.

A potential solution to address this need for more flexible harness systems is to use a distributed system of sensors and actuators communicating over a network. Power and communications are generally routed to the same locations on a vehicle, and therefore routing power and communications together to “smart” nodes which then interface with multiple sensors and/or actuators can provide for decentralized functionality to help reduce the impact of vehicle design changes. Traditional networked systems of sensors and actuators have a significant drawback in that they drastically increase the connector and pin count per unit sensor and/or actuator. In some cases, the increase in connector and pin count may require, for example, crimping multiple wires to a single pin, thereby introducing a large reliability concern. Hence, a need exists to create a “smart” node (sensor/actuator interface) to reduce the effective connector count of a bussed/networked wiring system to that of point-to-point wiring while still providing the adaptability of a bussed architecture.

Disclosed herein are localized control node devices (i.e., “smart node” devices) and systems for adaptive avionics applications. In one aspect, a smart node device comprises: a) a microcontroller; b) an electric power converter; and c) at least one circuit selected from the group consisting of a sensor interface circuit configured to capture data from at least one sensor, an actuator drive circuit configured to control at least one actuator, or any combination thereof; wherein the microcontroller is configured for electrical communication with the at least one circuit, with another smart node device, and with a system controller.

In some embodiments, the device further comprises no more than three external connectors. In some embodiments, the device further comprises no more than five external connectors. In some embodiments, the device comprises a sensor interface circuit and is configured to capture data from at least three sensors. In some embodiments, the device comprises a sensor interface circuit and is configured to capture data from at least four sensors. In some embodiments, the device comprises an actuator drive circuit and is configured to control at least three actuators. In some embodiments, the device comprises an actuator drive circuit and is configured to control at least four actuators. In some embodiments, the device comprises a sensor interface circuit that is configured as an interface for a resistance-temperature detector (RTD), thermocouple, or thermistor. In some embodiments, the device comprises a sensor interface circuit that is configured as an interface for a pressure sensor, a differential pressure sensor, a break-wire (short or open circuit) sensor for payload deployment or connector separation, a resistance sensor, a voltage sensor, or a current sensor. In some embodiments, the device comprises a sensor interface circuit that is configured as an interface for an optical time-of-flight (ToF) sensor, a thermal image sensor, a CMOS image sensor, or a CCD image sensor. In some embodiments, the device comprises an actuator drive circuit that is configured to control a valve, a solenoid, a switch, a relay, a light emitting diode (LED), a heater, a pyrotechnic device, a hydraulic actuator, a pneumatic actuator, an electrical actuator, or a motor. In some embodiments, the electric power converter is a direct current-to-direct current (DC/DC) converter circuit. In some embodiments, the microcontroller is further configured to provide digital communication with a system controller. In some embodiments, the microcontroller is configured to communicate a physical location address for the device to the system controller. In some embodiments, the device comprises a sensor interface circuit and the microcontroller is configured to transmit sensor data between the at least one sensor and the system controller in an individually-addressable fashion. In some embodiments, the device comprises an actuator drive circuit and the microcontroller is configured to transmit actuator control signals between the system controller and the at least one actuator in an individually-addressable fashion. In some embodiments, the microcontroller is configured to provide fault detection. In some embodiments, the microcontroller is configured to provide overcurrent detection. In some embodiments, the device further comprises a unique binary identification code that may be used to associate calibration data with that specific device.

In one aspect, a harness system comprises: a) two or more smart node devices, wherein each smart node device comprises: i) a microcontroller; an electric power converter; and at least one circuit selected from the group consisting of a sensor interface circuit configured to capture data from at least one sensor, an actuator drive circuit configured to control at least one actuator, or any combination thereof; wherein the microcontroller is configured for electrical communication with the at least one circuit, with another smart node device, and with a system controller; and b) a system controller.

In some embodiments, the harness system comprises at least three smart node devices. In some embodiments, the harness system comprises at least four smart node devices. In some embodiments, each smart node device further comprises no more than three external connectors. In some embodiments, each smart node device further comprises no more than five external connectors. In some embodiments, at least one smart node device comprises a sensor interface circuit and is configured to capture data from at least three sensors. In some embodiments, at least one smart node device comprises a sensor interface circuit and is configured to capture data from at least four sensors. In some embodiments, at least one smart node device comprises a sensor interface circuit that is configured as an interface for a resistance-temperature detector (RTD), thermocouple, or thermistor. In some embodiments, at least one smart node device comprises a sensor interface circuit that is configured as an interface for a pressure sensor, a differential pressure sensor, a break-wire (short or open circuit) sensor for payload deployment or connector separation, a resistance sensor, a voltage sensor, or a current sensor. In some embodiments, at least one smart node device comprises a sensor interface circuit that is configured as an interface for an optical time-of-flight (ToF) sensor, a thermal image sensor, a CMOS image sensor, or a CCD image sensor. In some embodiments, at least one smart node device comprises an actuator drive circuit that is configured to control a valve, a solenoid, a switch, a relay, a light emitting diode (LED), a heater, a pyrotechnic device, a hydraulic actuator, a pneumatic actuator, an electrical actuator, or a motor. In some embodiments, the microcontroller of each smart node device is configured to communicate a physical location address of the device to the system controller. In some embodiments, the microcontroller of each smart node device that comprises a sensor interface circuit is further configured to transmit sensor data between the at least one sensor and the system controller in an individually-addressable fashion. In some embodiments, the microcontroller of each smart node device that comprises an actuator drive circuit is further configured to transmit actuator control signals between the system controller and the at least one actuator in an individually-addressable fashion. In some embodiments, the harness system is configured for transmitting electrical power, sensor data, and actuator control signals between the system controller and two or more physical locations on an aerospace launch vehicle. In some embodiments, the aerospace launch vehicle comprises 3D-printed engine parts. In some embodiments, the harness system comprises fewer than 3 connectors per node on average. In some embodiments, the harness system comprises fewer than 2.5 connectors per node on average. In some embodiments, the harness system comprises fewer than 2.2 connectors per node on average. In some embodiments, the harness system comprises fewer than 2.1 connectors per node on average. In some embodiments, the harness system is configured to easily adjust the total number of smart nodes contained therein. In some embodiments, the harness system is configured to easily adjust the total number of nodes controlled thereby. In some embodiments, the system controller is configured to execute software that automatically re-configures the harness system when a smart node device is added to or removed from the harness system. In some embodiments, the harness is powered by a battery.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 provides an exemplary, non-limiting schematic illustration of a traditional point-to-point wiring harness architecture for a rocket engine.

FIG. 2 provides an exemplary, non-limiting schematic illustration of a star wiring harness architecture for a rocket engine.

FIG. 3 provides an exemplary, non-limiting schematic illustration of a bus or daisy chain wiring harness architecture for a rocket engine.

FIG. 4 provides an exemplary, non-limiting schematic illustration of a ring wiring harness architecture for a rocket engine.

FIG. 5 provides an exemplary, non-limiting schematic illustration of a traditional point-to-point wiring harness architecture for a rocket stage assembly.

FIG. 6 provides an exemplary, non-limiting schematic illustration of a star wiring harness architecture for a rocket stage assembly.

FIG. 7 provides an exemplary, non-limiting schematic illustration of a bus or daisy chain wiring harness architecture for a rocket stage assembly.

FIG. 8 provides an exemplary, non-limiting schematic illustration of a ring wiring harness architecture for a rocket stage assembly.

FIGS. 9A-C provide tables that summarize the set of assumptions made and the resulting estimates for design parameters for different wiring harness configurations for an exemplary rocket engine and rocket tank stage. FIG. 9A: summary of assumptions made regarding wire length factors (based on assumed distributions of sensors/actuators) and connector multipliers used for estimating wiring harness metrics for different wiring harness architectures. FIG. 9B: summary of the resulting estimates for the total length of wiring required, the number of connectors, and the number of pins required for each wiring harness architecture as applied to designing a harness for the Aeon-1 engine. FIG. 9C: summary of results for the total length of wiring required, the number of connectors, and the number of pins required for each wiring harness architecture as applied to designing a wire harness for a rocket tank stage.

FIG. 10 provides an exemplary, non-limiting illustration of a conventional bus wiring harness architecture comprising a series of passive T-connectors.

FIG. 11 provides an exemplary, non-limiting schematic illustration of a “Pylon” smart node device.

FIG. 12 provides an exemplary, non-limiting illustration of a “smart” wiring harness architecture comprising a plurality of “Pylon” smart node devices.

FIG. 13 provides another exemplary, non-limiting illustration of a “smart” wiring harness architecture comprising a plurality of “Pylon” smart node devices.

FIG. 14 provides an exemplary, non-limiting illustration of the number of nodes and connectors required in a conventional “homogeneous” point-to-point wiring harness architecture as a function of the number of sensors or valves to be included in the harness system.

FIG. 15 provides an exemplary, non-limiting illustration of the number of nodes and connectors required in a conventional “single origin” point-to-point wiring harness architecture as a function of the number of sensors or valves to be included in the harness system.

FIG. 16 provides a table that summarizes the number of connectors required as a function of the number of nodes in a wire harness for smart node “Pylon” devices that are connected to one, two, three, or four sensors/actuators respectively, and a comparison to that for conventional homogeneous and SWaP optimized point-to-point bus architectures.

FIG. 17 provides an exemplary, non-limiting illustration of a plot of connector count versus number of nodes served for different connector-to-node ratios, and a comparison that for conventional single origin and homogeneous point-to-point bus architectures.

FIG. 18 provides an exemplary, non-limiting illustration of a plot of the total number of connectors required as a function of the number of sensor/actuator nodes in a “smart” wiring harness architecture for different connector-to-node ratios.

FIG. 19 provides an exemplary, non-limiting schematic illustration of a computer system.

### DETAILED DESCRIPTION

Disclosed herein are localized control node devices (i.e., “smart node” or “Pylon” devices) and wiring harness systems that address the need for more flexible wiring harness designs for adaptive avionics applications. By placing localized control nodes that are configured to communicate with each other and/or a system controller and that comprise multiple sensor and/or actuator interfaces at each node at various locations on a vehicle, one may create a flexible, easily-reconfigured wiring harness for which the overall connector count required asymptotically approaches a value of two connectors per end point, matching that for a centralized point-to-point architecture. This is in contrast to conventional bussed/networked wiring harness designs that require four or more connectors per sensor or actuator, or require less reliable double-crimped harnessing or custom sensors with optimized connectors for buses.

The disclosed smart node devices may be used in any bused communication network, i.e., any network solution that allows either “tapping off” of a bus or routing signals through each node with an input/output signal that is conditioned and retransmitted, to create flexible, easily-reconfigured wire harness systems. Any of a variety of sensors may be interfaced with the disclosed smart node devices, including those comprising digital and/or analog communication modes, e.g., frequency, voltage, current (e.g., current loop, 4-20 mA), ratiometric, pulse per second, etc. In addition, any of a variety of actuators may be interfaced with the disclosed smart node devices, examples of which will be discussed in more detail below.

With the system controller electronics controlling communications and power distribution at each smart node device, it also becomes possible to provide unique identifiers (e.g., unique binary identification codes) for every smart node device, which may subsequently be correlated with unique identifiers (e.g., barcodes) for specific locations on a vehicle and therefore enable automatic vehicle harness configuration and/or re-configuration and also enable automated software configuration loads to be built and pushed to the vehicle avionics. Smart node device calibration data can also be stored within each device, and may be processed/compressed at each node once the harness system has been configured, thereby providing better network performance.

In one aspect, the smart node devices of the present disclosure may comprise: a) a microcontroller; b) an electric power converter; and c) at least one circuit selected from the group consisting of a sensor interface circuit configured to capture data from at least one sensor, an actuator drive circuit configured to control at least one actuator, or any combination thereof; wherein the microcontroller is configured for electrical communication with the at least one circuit, with another smart node device, with a system controller, or for any combination thereof. In some instances, each smart node device may comprise three or more external connectors for interfacing with sensors and/or actuators. In some instances, the smart node devices may be configured to provide fault detection and/or overcurrent detection.

In one aspect, the harness systems of the present disclosure may comprise: a) two or more smart node devices, wherein each smart node device comprises: i) a microcontroller; an electric power converter; and at least one circuit selected from the group consisting of a sensor interface circuit configured to capture data from at least one sensor, an actuator drive circuit configured to control at least one actuator, or any combination thereof; wherein the microcontroller is configured for electrical communication with the at least one circuit, with another smart node device, with a system controller, or with any combination thereof; and b) a system controller. In some instances, the “smart” harness systems of the present disclosure may comprise at least three smart node devices. In some instances, the smart node devices of the disclosed smart harness systems may each be configured to capture data from at least three sensors and/or to provide control of at least three actuators. In some instances, the smart harness systems of the present disclosure may be configured for transmitting electrical power, sensor data, and actuator control signals between the system controller and two or more physical locations on an aerospace launch vehicle. In some instances, the aerospace launch vehicle may comprise three-dimensional (3D) printed engine parts, engines, housings, and/or other vehicle components. In some instances, the disclosed smart harness systems may comprise fewer than 3 connectors per node on average. In some instances, the disclosed smart harness systems are configured to easily change or adjust the total number of nodes (e.g., smart nodes) contained in the harness system. In some instances, the system controller is configured to execute software that automatically re-configures the harness system when a smart node device is added to or removed from the harness system. In some instances, the smart harness systems of the present disclosure may be powered by a battery.

### Definitions

Unless otherwise defined, all technical terms used herein have the same meaning as commonly understood by one of ordinary skill in the art in the field to which this disclosure belongs.

As used in this specification and the appended claims, the singular forms “a”, “an”, and “the” include plural references unless the context clearly dictates otherwise. Any reference to “or” herein is intended to encompass “and/or” unless otherwise stated.

As used herein, the term ‘about’ a number refers to that number plus or minus 10% of that number. The term ‘about’ when used in the context of a range refers to that range minus 10% of its lowest value and plus 10% of its greatest value.

As used herein, the terms “harness”, “wiring harness”, and “harness system” are used interchangeably, and may refer to an assembly of electrical wires (or cables), connectors, and other parts which transmit signals or electrical power in a vehicle (also sometimes referred to as a cable assembly).

As used herein, the term “node” may refer to a connection point in a wiring harness system that provides a means for transmitting electrical power, actuator control signals, sensor data, and/or other signals to and from a system controller to a plurality of sensors and/or actuators, i.e., the number of nodes is equal to the number of sensors and/or actuators in the system.

As used herein, the terms “smart node device”, “localized control node device”, or “Pylon device” are used interchangeably and may refer to interchangeable or fixed components of a wiring harness system that are configured to transmit electrical power, actuator control signals, sensor data, and/or other signals in an addressable manner to and from a system controller and/or other smart and/or passive node devices.

As used herein, the term “connector” may refer to a component for joining electrical circuits and/or wires together, and generally comprises a “male” part and a “female” part that mate.

As used herein, the term “microcontroller” may refer to a compact integrated circuit designed to govern a specific operation in an embedded system. In some instances, a microcontroller may include a processor (or microprocessor), memory, and input/output (I/O) peripherals on a single chip.

As used herein, the term “electric power converter” may refer to a device or electrical circuit for converting electric energy from one form to another, such as for converting between alternating current (AC) and direct current (DC), for changing the voltage or frequency of an electrical signal, or for some combination of these functions. In some instances an electrical power converter may be a “direct current-to-direct current (DC/DC) converter”, i.e., an electronic circuit or electromechanical device that converts a source of direct current from one voltage level to another.

As used herein, the term “sensor interface circuit” may refer to an electrical circuit configured to transmit control signals (e.g., binary and/or analog control signals) and/or receive sensor data signals (e.g., binary and/or analog data signals) from at least one sensor device. In some instances, a sensor interface circuit may be integrated with a microcontroller on a single chip.

As used herein, the term “actuator drive circuit” may refer to an electrical circuit configured to transmit control signals (e.g., binary and/or analog control signals) and/or power to at least one actuator. In some instances, an actuator drive circuit may be integrated with a microcontroller on a single chip.

### Avionics Wiring Harness Architectures:

As is the case for other types of vehicles, a wiring harness is used to connect different components of a flight vehicle's electronic control system. As noted above, a large portion of avionics wire harnessing and circuitry is dedicated to power and communications delivery to sensors and actuators. Because sensors and/or actuators may be positioned at a variety of different locations on a flight vehicle, the wiring harness used to connect them with the system controller typically comprises a custom harness design. Although traditionally size, weight, and power requirements are key design criteria when designing and developing flight vehicles, or components thereof (including the wiring harness), with the advent of 3D printing and other rapid prototyping and manufacturing tools, design flexibility is also becoming increasingly important for avoiding costly development delays. Hence, wiring harness architectures that maximize flexibility in terms of initial configuration and reconfiguration when sensors or actuators are added or removed, while still minimizing size, weight, and power requirements, are becoming increasingly important.

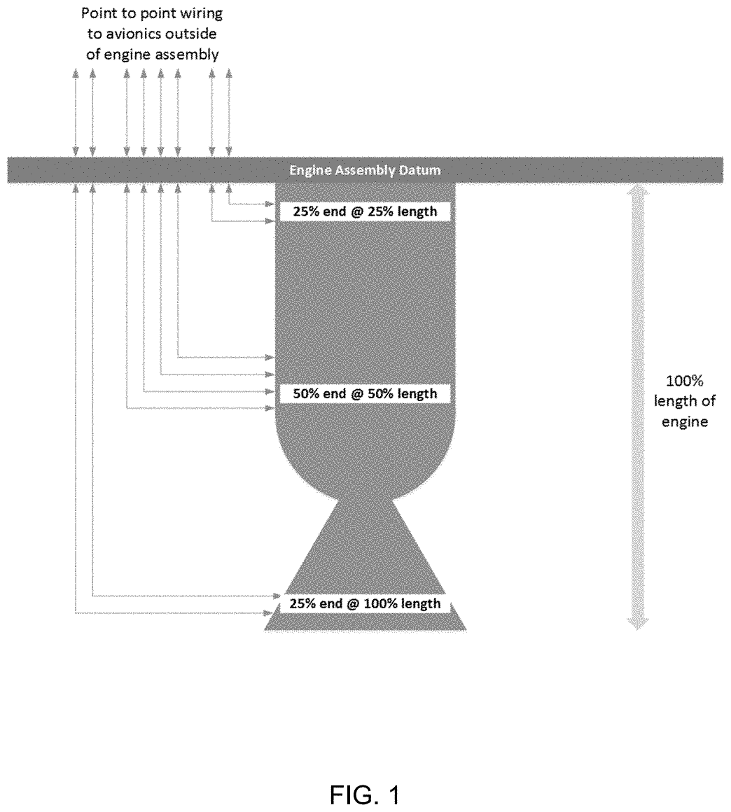

Examples of conventional wiring harness architectures are illustrated schematically in FIGS. 1-4. FIG. 1 illustrates a point-to-point wiring harness for the Aeon-1 launch vehicle engine (Relativity Space, Inc., Los Angeles, Calif.) in which each sensor or actuator is wired directly to a system controller. The arrows illustrate a point-to-point wiring harness model for an assumed sensor/actuator distribution, with 25% of the sensors/actuators assumed to be located at a distance of 25% of the length of the engine, 50% of the sensors/actuators assumed to be located at a distance of 50% of the length of the engine, and the remaining 25% assumed to be located at a distance of 100% of the length of the engine. These assumptions result in an average wire length of 56.25% the length of the engine relative to the engine assembly datum indicated in the figure. The wires may actually extend beyond this datum, as indicated, but this models the engine itself and what harnessing/connector effects a specific wiring harness architecture may have. Using this data, one can compare different architectures using the same assumptions based on real-world implementations.

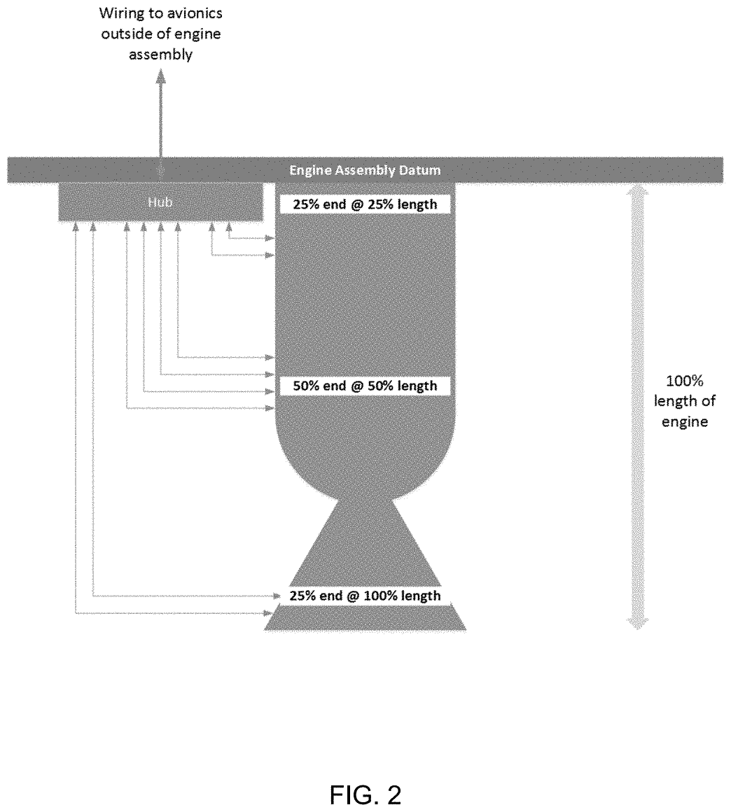

FIG. 2 illustrates a star wiring harness, i.e., a spoke and hub architecture, where individual sensors or actuators are connected by wires to a central communications and power bus that is then connected to the system controller. This architecture is essentially the same as point-to-point approach but with a local “hub” (e.g., a network switch is a “smart hub” for Ethernet communications). For the same assumptions regarding sensor/actuator distribution, the result is the same as that obtained for the point-to-point architecture (an average wire length of 56.25% the length of the engine), but there is an additional piece of avionics hardware located on the engine and the wiring from the hub to the rest of vehicle avionics can be simplified (e.g., using a single CAT5 cable for Ethernet communications).

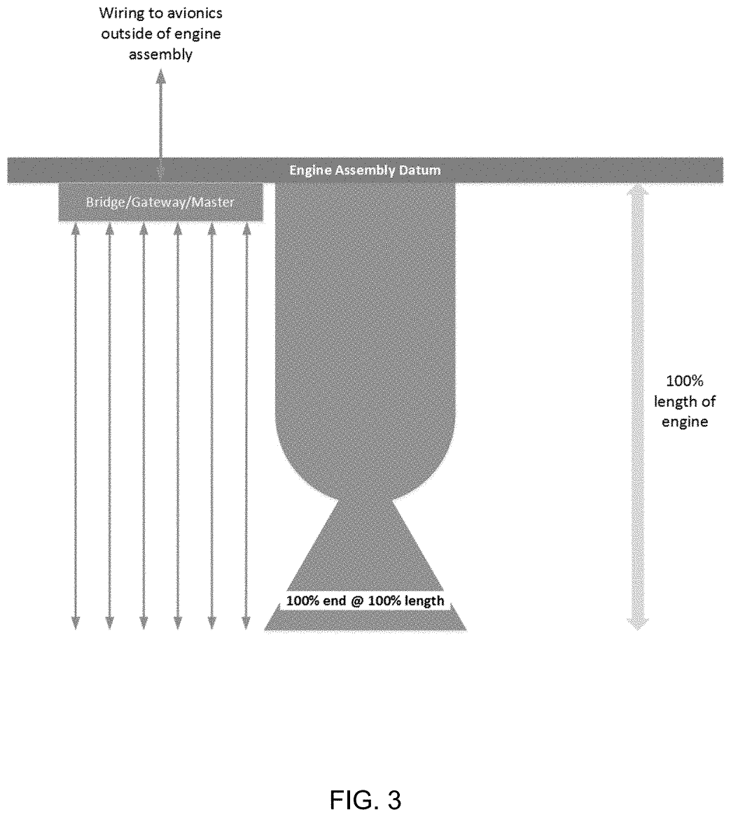

FIG. 3 illustrates a bus or daisy chain wiring harness, i.e., where the sensors or actuators are connected to a single communications bus via the use of T-connectors (bus wiring harness), or in series via a two-way link between one sensor or actuator and the next, with one end of the chain connected to the system controller (daisy chain wiring harness). Again, the same assumptions regarding sensor/actuator distribution were made. However, since bus and daisy-chain architectures may use a variety of different wire routing paths (e.g., a bus could serve sensors located only halfway down the rocket engine, but may wrap around the engine such that the wires are the length of the engine anyway; other wire routing paths could be substantially shorter). For present purposes, therefore, we simply assumed that any bus that is necessary automatically extends the length of the engine (i.e., that the average wire length is 100% of the overall length of the engine). Also, all buses and daisy chain networks require some sort of bridge/gateway/master component that controls communication over the bus, as illustrated in the figure.

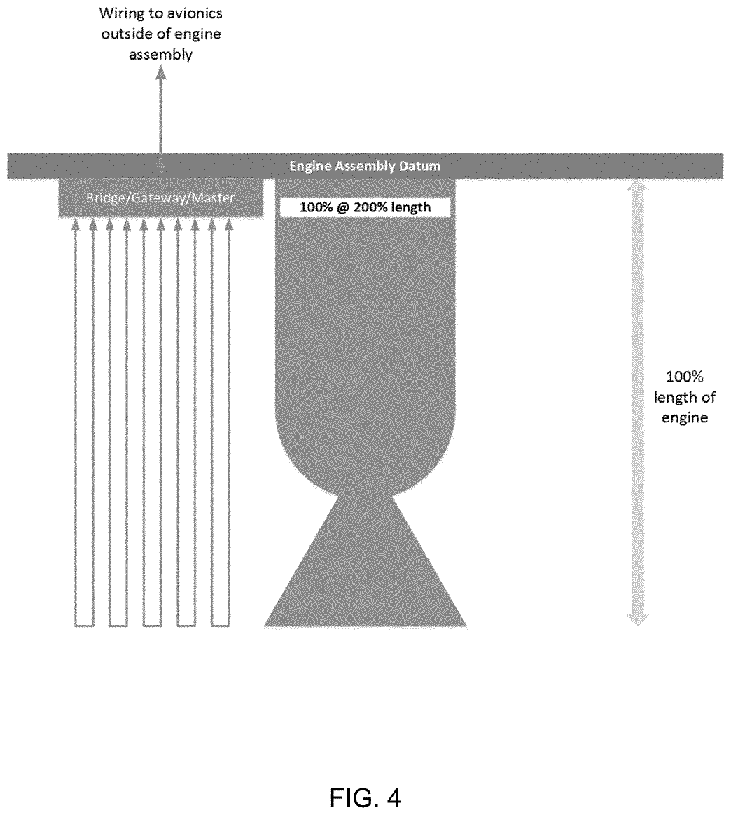

FIG. 4 illustrates a ring wiring harness, i.e., where the sensors or actuators are connected in series via a two-way link between one sensor or actuator and the next, and with both ends of the chain connected to the system controller. The ring wiring harness architecture is similar to a bus, but ring networks always have two paths for data to communicate. Therefore, as for the unknown wire routing path lengths for buses, we simply assumed that any ring network extends twice as long as the engine (out and back), and the average wire length will be 200% of the overall length of the engine. As with bus and daisy chain networks, ring networks require a bridge/gateway/master component.

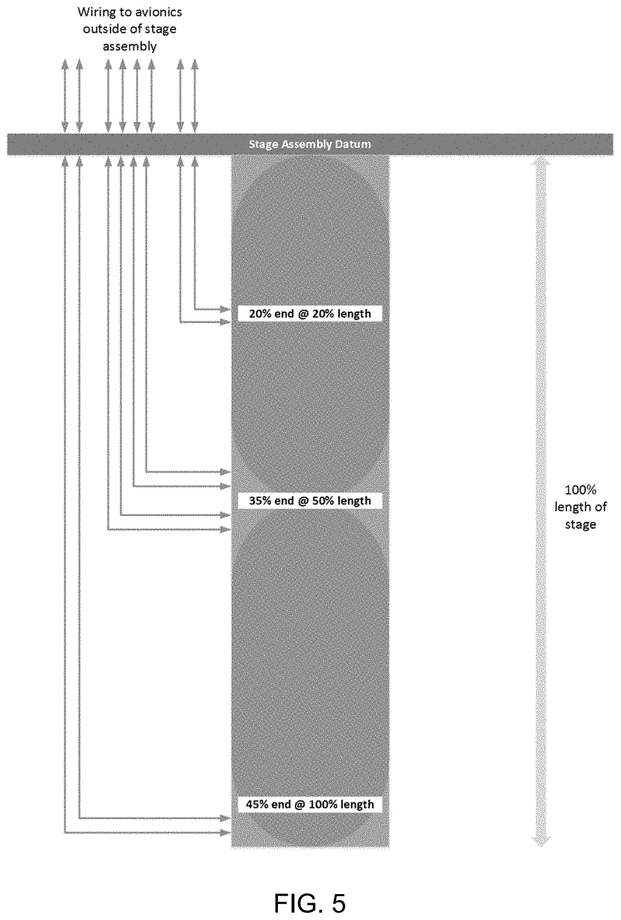

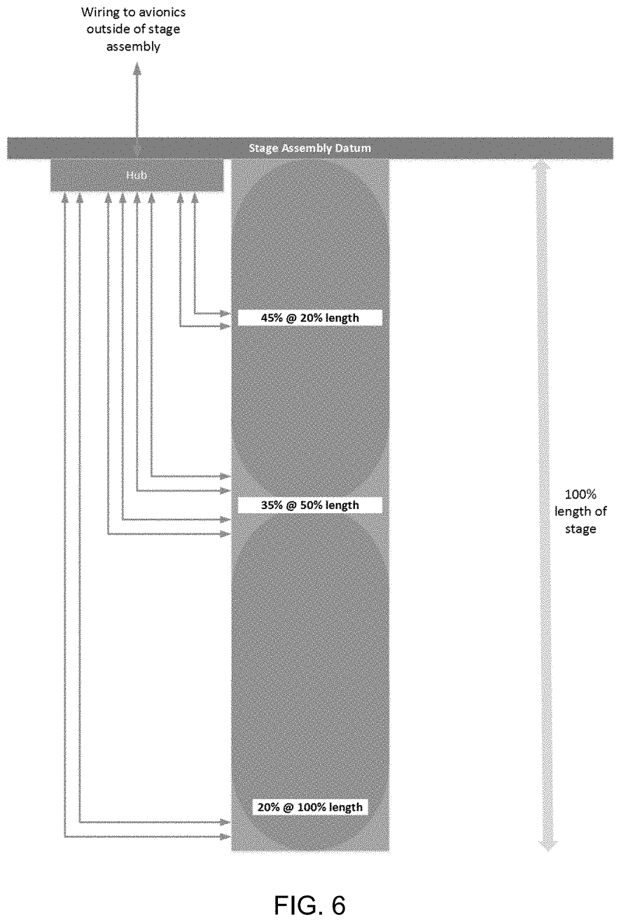

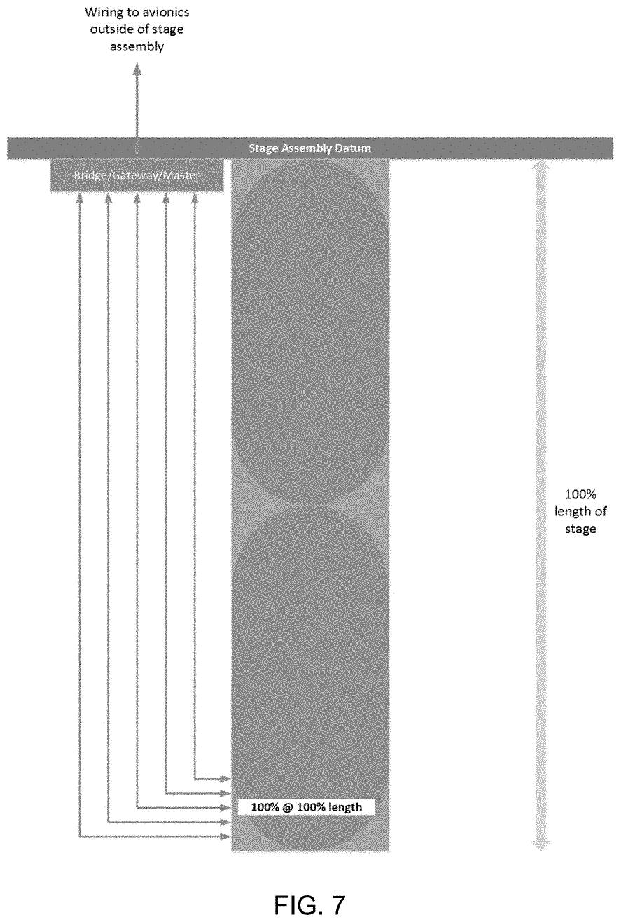

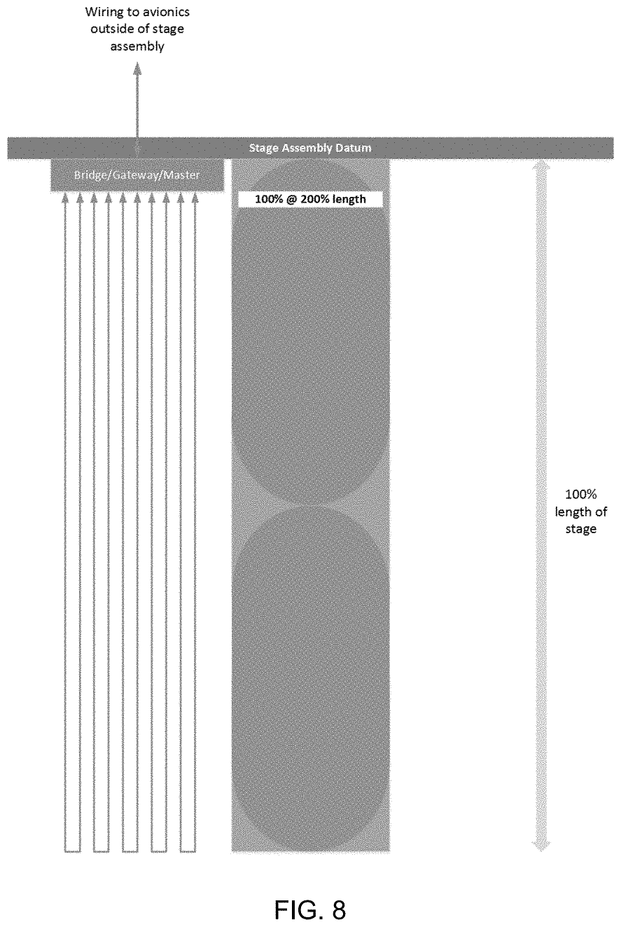

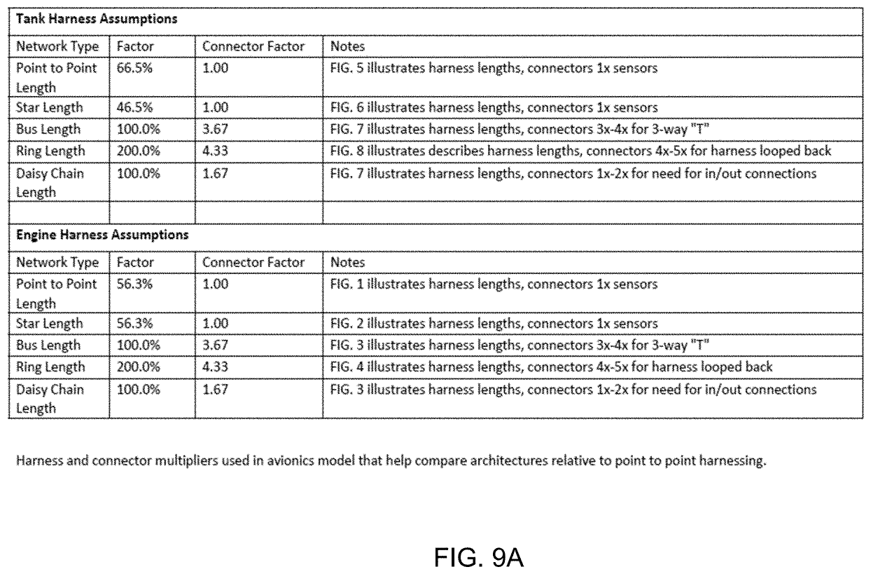

FIGS. 5-8 provide non-limiting, schematic illustrations of conventional wiring harness architectures as applied to the wiring of sensors and/or actuators distributed over a rocket stage assembly. FIG. 5 illustrates a point-to-point wiring harness architecture. For the indicated assumed distribution of sensor/actuators along the length of the stage, the average wire length was 66.5% of the overall length of the stage. FIG. 6 illustrates a star wiring harness architecture. For the indicated assumed distribution of sensor/actuators along the length of the stage, the average wire length was 46.5% of the overall length of the stage. FIG. 7 illustrates a bus or daisy chain architecture. Because a variety of different wire routing paths are possible, it was assumed that the average wire length is 100% of the overall length of the stage. FIG. 8 illustrates a ring wiring harness architecture. Again, because a variety of different wire routing paths are possible, and because a ring architecture requires wiring in both the “out” and “back” directions, it was assumed that the average wire length is 200% of the overall length of the stage.

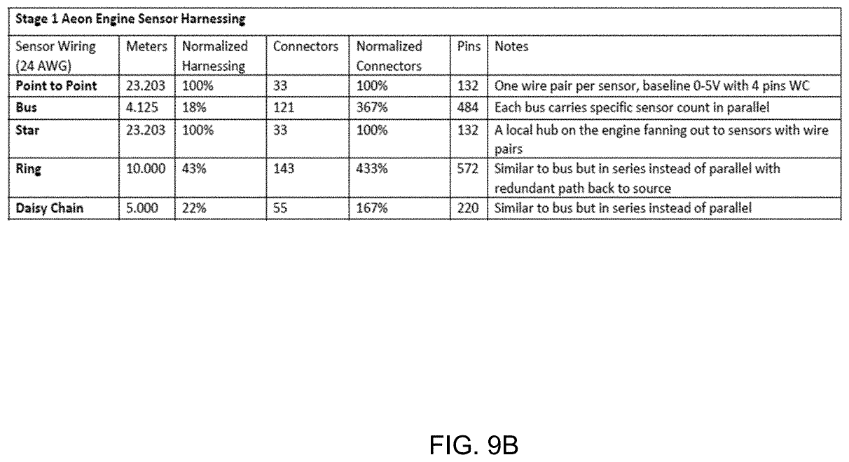

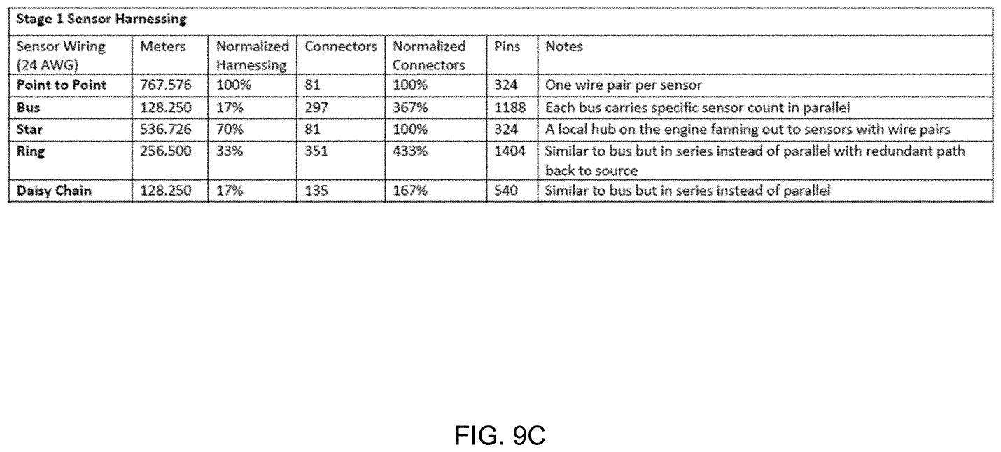

FIGS. 9A-C provide tables that summarize the underlying assumptions regarding the distribution of sensors and/or actuators along the length of the engine (or the resulting wire length factor), and show a comparison of design parameters for different wiring harness configurations for the Aeon-1 engine and a rocket tank stage. Sensors and actuators were assumed to require 1 wire pair (two wires) in all cases except 0-5V sensors, where they were assumed to require two wire pairs (four wires, 4-pins). Additionally, bus harnesses with bus communications and power were assumed to require two wire pairs (one for power, one for communications).

FIG. 9A summarizes the assumptions made regarding wire length factors (based on assumed distributions of sensors/actuators) and connector multipliers used in an avionics models to compare wire harness architectures for a rocket engine and a rocket tank stage relative to point-to-point harnessing.

FIG. 9B tabulates the resulting estimates for the total length of wiring required, the number of connectors, and the number of pins required for each wiring harness architecture as applied to designing a harness for the Aeon-1 engine using the assumptions described above and illustrated in FIGS. 1-4. The table also presents the results as normalized to those for the point-to-point architecture. Star networks required the same length of wiring and number of pins and connectors as the point-to-point architecture. Bus networks and daisy chain networks had nearly the same requirements, but bus networks required a passive T-connector (assumed) which forced an increase of greater than 2× in pin count compared to a daisy chain topology. The bus and daisy chain topologies present clear advantages. They enable the use of wiring harness lengths of roughly 20% that for star and point-to-point architectures. Since daisy chain networks require an in/out connector on each sensor, they require almost twice the number of connectors as a star configuration, but since the sensors themselves would likely need to be of a custom design the daisy chain architecture only makes sense if the other savings achieved with respect to harness length and/or performance benefits were worth the cost of manufacturing custom sensors.

FIG. 9C tabulates similar results for the total length of wiring required, the number of connectors, and the number of pins required for each wiring harness architecture as applied to designing a harness for a rocket tank stage using the assumptions described above and illustrated in FIGS. 5-8. Again, the normalized results are relative to the point-to-point harness and connector calculations.

Bus harness topologies have hidden costs that need to be considered. In many circumstances, buses introduce more connector and pins, which adds manufacturing costs and reliability risk if implemented in a passive way. These costs are mitigated if the sensor supports an input/output bus communications pin-out, but most presently available CANbus sensors (i.e., sensors designed to work with a Controller Area Network (CANbus)—a robust vehicle bus standard designed to allow microcontrollers and devices to communicate with each other in applications without a host computer) only offer two pins for communications. This presents the following challenges with bus architectures for communication with sensors and control of actuators:
“T”-adapters are required for most commercial, off-the-shelf CANbus sensors to avoid crimping two wires in one pin.
The bus architecture typically requires a 3×-5× increase in connector count (compared to the point-to-point architecture) in the worst-case scenario.
The bus architecture requires one “T”-adapter per sensor, and therefore makes the effective mass of the sensors larger, or requires one to build custom sensors with two connectors (in and out) or one connector with two pairs of pins (in and out) that would then require a custom, non-reconfigurable harness comprising fixed wire lengths.

While these factors constitute a challenging aspect for the use of bus topologies, they could be mitigated by several approaches, including:
Use of standardized harnesses that can be mass produced and reduce the need for manual crimping (but at the cost of reduced harness design flexibility, and subsequent delays when engine or vehicle design changes are implemented during development).
For aerospace applications, removing the shielding to allow the use of plastic automotive connectors which may not only reduce harness mass but connector mass (at the risk of increased electromagnetic interference (EMI) and lightning susceptibility). In some embodiments, shielding is a metal braid/foil that completely encapsulates wire conductor(s) inside the shield thus providing a Faraday cage for the wire(s) inside. In some embodiments, this shield is connected to chassis ground.
Crimping two wires into one pin to mitigate the need for a “T” adapter (but at the expense of reduced reliability, and any change in sensor count or location will force a harness design change as well).
The use of bus sensors with input/output connectors make the bus equivalent to a daisy chain topology without the additional engineering required for daisy chain information routing (but at the expense of additional manufacturing cost for custom sensors)
The use of a localized control node device (i.e., a “smart node” or “Pylon” device), as will be described in more detail below.

### Smart Node Devices:

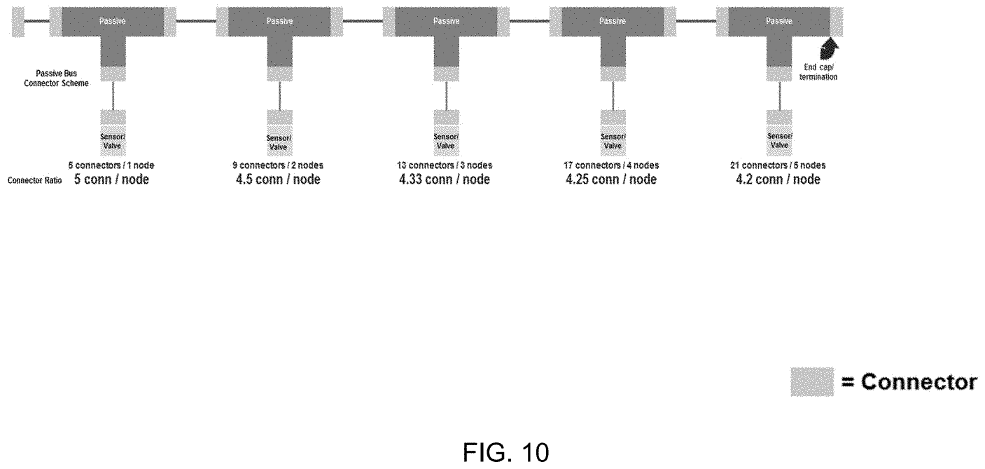

During development of the Terran 1 avionics model (Relativity Space, Inc., Los Angeles, Calif.), it became clear that bused architectures have an “Achilles heel” of increasing connector and pin count by at least 3× compared to point-to-point architectures, or require crimping two wires in a single pin which raises a large reliability concern, and in some instances, force custom wire harnessing that must be modified or replaced with any change in sensor/actuator count or location on the vehicle. The requirement for extra connectors comes from the need to tap off the communications bus using a passive T-connector for each sensor or actuator, as illustrated in FIG. 10. As illustrated in FIG. 10, a conventional bus comprising one node (i.e., a single connection point for a sensor or actuator) would require 5 connectors per node, a conventional bus comprising two nodes would require 4.5 connectors per node (9 connectors in total), and so on.

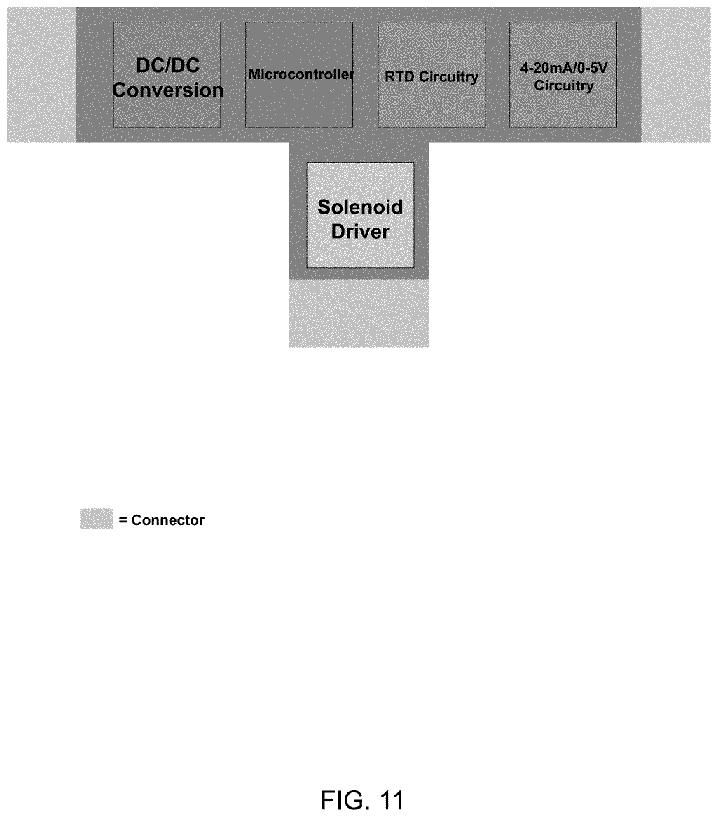

Amortizing the requirement for additional connectors by putting active components inside a “T” adapter, thereby creating a localized control node (i.e., a “smart node” or “Pylon” device; see, for example, FIG. 11), dramatically reduces the increase in connector count versus number of sensor and/or actuator nodes by taking advantage of bus I/O and addressable node features, such that for a wire harness system comprising about 12 nodes or more the total number of connectors required to support the bus is approaches that for point-to-point harnessing. This aspect of using smart node devices to assemble component-efficient, flexible, easily reconfigured wire harness systems of reduced complexity will be discussed in more detail below, and is applicable to many different vehicle wire harnessing applications beyond just that of launch vehicle or other aerospace applications.

FIG. 11 provides a non-limiting schematic illustration of a smart node device in one aspect of the present disclosure, where the device is designed to facilitate the transmission of control signals, data signals, and/or power between a system controller and a plurality of sensors and/or actuators in an addressable manner via a wiring harness. Examples of electrical circuits and components that may be incorporated into the device include, but are not limited to, microcontrollers (e.g., to provide logic and CANbus communications), electrical power converters (e.g., DC/DC converters for converting an unregulated voltage to another regulated voltage, as well as for providing electric isolation), circuitry for interfacing with different types of sensors (e.g., resistance-temperature detector (RTD) circuitry and/or 4-20 mA/0-5V circuitry for interfacing with pressure sensors, current loop sensors, etc.), actuator drive circuitry (e.g., a constant current circuit, constant voltage circuit, or pulse-width modulation (PWM) circuit for providing the high currents required to drive valve actuators, etc.), and connectors, etc.

In some instances, the smart node device may comprise firmware that captures analog measurements and provides control for actuators such as valves and pyrotechnic channels. In some instances, the microcontroller in the device may be configured to provide overcurrent and/or fault detection, e.g., where the firmware residing on the device further provides a local control loop (i.e., smart fusing). In some instances, the smart node device may further comprise a unique identification code (e.g., a unique binary number laser etched in the integrated circuit (IC) die, or a unique programmed code) that may be used to associate test and calibration data with that specific device. In some instances, the correlation of unique smart node device identification codes with, e.g., barcodes that identify specific locations on the vehicle where the devices are located may enable auto-configuration functionality for the vehicle, i.e., since the exact location of each smart node device is known just by querying the vehicle, one may load configuration software packages (or re-configuration software packages) in an automated fashion. In some instances, smart node devices may be “armed” such that a broadcast message synchronously causes all listening devices to “fire”, e.g., trigger a pyrotechnic device, open or close a valve, etc.

In some instances, the smart node devices may comprise a series of individual components (e.g., electrical power converters, sensor interface circuits, actuator drive circuits, and connectors, etc.) that are tied to the microcontroller. In some instances, all of the required functionality may be implemented on a single integrated circuit. In general, the devices will be designed and manufactured to withstand the extreme vibration, shock, and temperature environments that aircraft, artificial satellites, launch vehicles, and spacecraft may be subjected to.

In some instances, a smart node device may comprise a connector-to-node ratio ranging from 1 to 10 (i.e., so that the number of sensors and/or actuators connected to a single smart node device ranges from 1 to 10). In some instances, the connector-to-node ratio may be at least 1, at least 2, at least 3, at least 4, at least 5, at least 6, at least 7, at least 8, at least 9, or at least 10. In some instances, the connector-to-node ratio may be at most 10, at most 9, at most 8, at most 7, at most 6, at most 5, at most 4, at most 3, at most 2, or at most 1. Any of the lower and upper values described in this paragraph may be combined to form a range included within the present disclosure, for example, in some instances the connector-to-node ratio may range from 2 to 5. Those of skill in the art will recognize that the connector-to-node ratio may have any value within this range, e.g., 3.

In some instances, the smart node device may be configured to capture data from 1 to 10 sensors. In some instances, the smart node device may be configured to capture data from at least 1, at least 2, at least 3, at least 4, at least 5, at least 6, at least 7, at least 8, at least 9, or at least 10 sensors. In some instances, the smart node device may be configured to capture data from at most 10, at most 9, at most 8, at most 7, at most 6, at most 5, at most 4, at most 3, at most 2, or at most 1 sensor. Any of the lower and upper values described in this paragraph may be combined to form a range included within the present disclosure, for example, in some instances the smart node device may be configured to capture data from 3 to 6 sensors. Those of skill in the art will recognize that the smart node device may be configured to capture data from any number of sensors within this range, e.g., from 5 sensors.

In some instances, the smart node device may be configured to control from 1 to 10 actuators. In some instances, the smart node device may be configured to control at least 1, at least 2, at least 3, at least 4, at least 5, at least 6, at least 7, at least 8, at least 9, or at least 10 actuators. In some instances, the smart node device may be configured to control at most 10, at most 9, at most 8, at most 7, at most 6, at most 5, at most 4, at most 3, at most 2, or at most 1 actuator. Any of the lower and upper values described in this paragraph may be combined to form a range included within the present disclosure, for example, in some instances the smart node device may be configured to control from 3 to 6 actuators. Those of skill in the art will recognize that the smart node device may be configured to control any number of actuators within this range, e.g., 2 actuators.

In some instances, the microcontroller of the smart node device is configured for electrical communication with at least one sensor interface or actuator drive circuit, with another smart node device, with a system controller, or with any combination thereof.

### Microcontrollers:

A microcontroller (also sometimes referred to as an embedded controller or microcontroller unit (MCU)) is a compact integrated circuit designed to govern a specific operation in an embedded system. A typical microcontroller includes a processor, memory, and input/output (I/O) peripherals on a single chip. A microcontroller's processor may vary by application. For example, in some instances, the microcontroller may comprise a simple 4-bit, 8-bit or 16-bit processor. In some instances, the microcontroller may comprise a more complex 32-bit or 64-bit processor. In some instances, the microcontroller may use random access memory (RAM), flash memory, erasable programmable read-only memory (EPROM), electrically erasable programmable read-only memory (EEPROM), or any combination thereof. In general, microcontrollers are designed to be usable without additional computing components because they are designed with sufficient onboard memory. They also provide pins for general I/O operations, so they may in some instances directly interface with sensors and other components.

In some instances, the programming of microcontroller processors may be based on complex instruction set computing (CISC). In some instances, the programming of microcontroller processors may be based on reduced instruction set computing (RISC). CISC generally has around 80 instructions (RISC has about 30), as well as more addressing modes (12-24 compared to RISC's 3-5). While CISC may be easier to implement and has more efficient memory use, in some instances it may also exhibit performance degradation due to the higher number of clock cycles required to execute instructions. RISC (which places more emphasis on software) may provide better performance than CISC processors (which place more emphasis on hardware) due to its simplified instruction set and, therefore, increased design simplicity. The choice of using CISC versus RISC computing may vary depending on application.

In some instances, microcontrollers may be programmed using assembly language. In some instances, microcontrollers may be programmed using other languages, e.g., the C programming language.

In some instances, microcontrollers provide input and output pins to implement peripheral functions. Such functions may include, but are not limited to, analog-to-digital converters, liquid crystal display (LCD) controllers, real-time clock (RTC), synchronous/asynchronous receiver transmitter (USART), timers, universal asynchronous receiver transmitter (UART) and universal serial bus (USB) connectivity. Sensors that gather data related to temperature, pressure, etc., may also be interfaced with microcontrollers.

Examples of microcontrollers that may be used in implementing the disclosed smart node devices include, but are not limited to, the Intel MCS-51 (often referred to as an 8051 microcontroller), the AVR microcontroller developed by Atmel; the programmable interface controller (PIC) from Microchip Technology; and various licensed ARM microcontrollers. A number of companies manufacture and sell microcontrollers, including NXP Semiconductor (Einidhoven, Netherlands), Renesas Electronics (Tokyo, Japan), Silicon Labs (Austin, Tex.), and Texas Instruments (Dallas, Tex.).

### Sensors:

The smart node devices of the present disclosure may be configured to communicate with and capture data from any of a variety of sensors known to those of skill in the art. Examples include, but are not limited to, resistance-temperature (RTD) detectors, thermocouples, thermistors, pressure sensors, differential pressure sensors, stress/strain sensors, optical time-of-flight (ToF) sensors, thermal image sensors, CMOS image sensors, CCD image sensors, break-wire (short or open circuit) sensors for payload deployment or connector separation, resistance sensors, voltage sensors, current sensors, or any combination thereof.

### Actuators:

The smart node devices of the present disclosure may be configured to control any of a variety of actuators or other devices known to those of skill in the art. Examples include, but are not limited to, valves, solenoids, switches, relays, light emitting diodes (LEDs), heaters, pyrotechnic devices (e.g., igniters), hydraulic actuators, pneumatic actuators, electrical actuators, motors, or any combination thereof.

### Wiring Harness Systems:

As noted above, the disclosed smart node devices may dramatically reduce the connector count required to communicate with and/or control a plurality of sensors and/or actuators by taking advantage of bus I/O and addressable node features. More importantly, they may be used to efficient, flexible, easily reconfigured wire harness systems for use with any of a variety of vehicles including, but not limited to, automobiles, aircraft, satellites, aerospace vehicles (e.g., launch vehicles), etc. In one aspect, the disclosed smart node devices and wire harness systems are particularly useful for vehicles, e.g., aerospace launch vehicles, developed using rapid prototyping tools. The easily reconfigured wire harness systems of the present disclosure allow one to easily accommodate design changes during development without incurring the extensive costs and delays associated with having to redesign and manufacture a conventional custom wire harness.

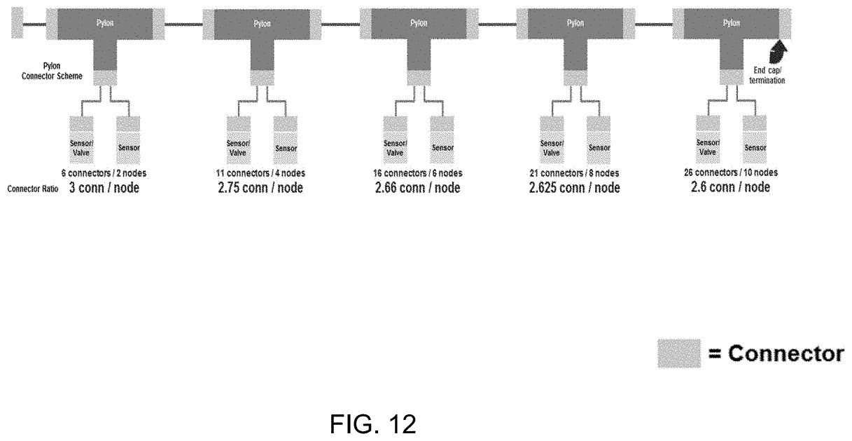

FIG. 12 provides an exemplary, non-limiting illustration of a “smart” wiring harness architecture comprising a plurality of “Pylon” smart node devices where each smart node device interfaces with two sensors (or one sensor and one valve). As can be seen, the average number of connectors required per sensor or actuator node in the harness system decreases as the number of smart node devices increases. The average number of connectors per node decreases from 3.0 for a harness comprising one smart node to 2.6 for a harness comprising five smart nodes.

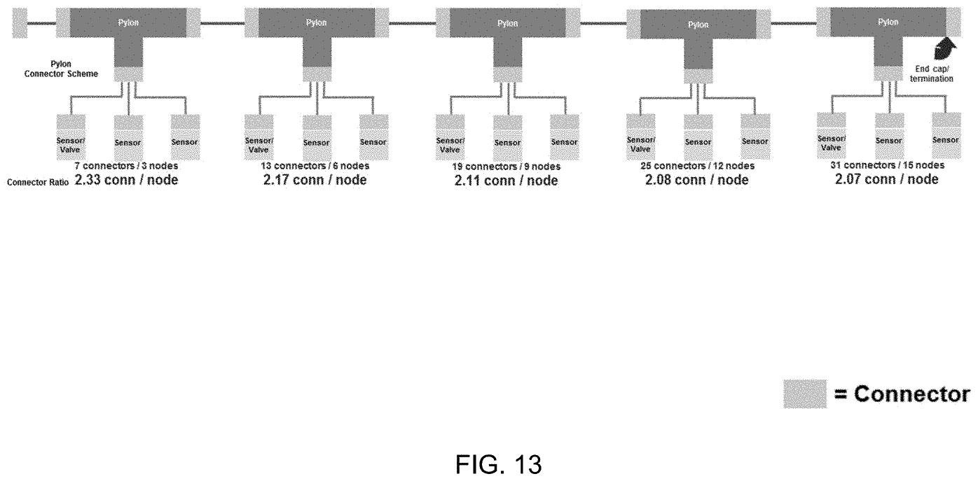

FIG. 13 provides another exemplary, non-limiting illustration of a “smart” wiring harness architecture comprising a plurality of “Pylon” smart node devices where each smart node device interfaces with three sensors (e.g., three sensors, or two sensors and one valve). Again, the average number of connectors required per sensor or actuator node in the harness system decreases as the number of smart node devices increases, in this case reaching an average value of just 2.07 connectors per sensor or actuator node for a harness system comprising five smart node devices.

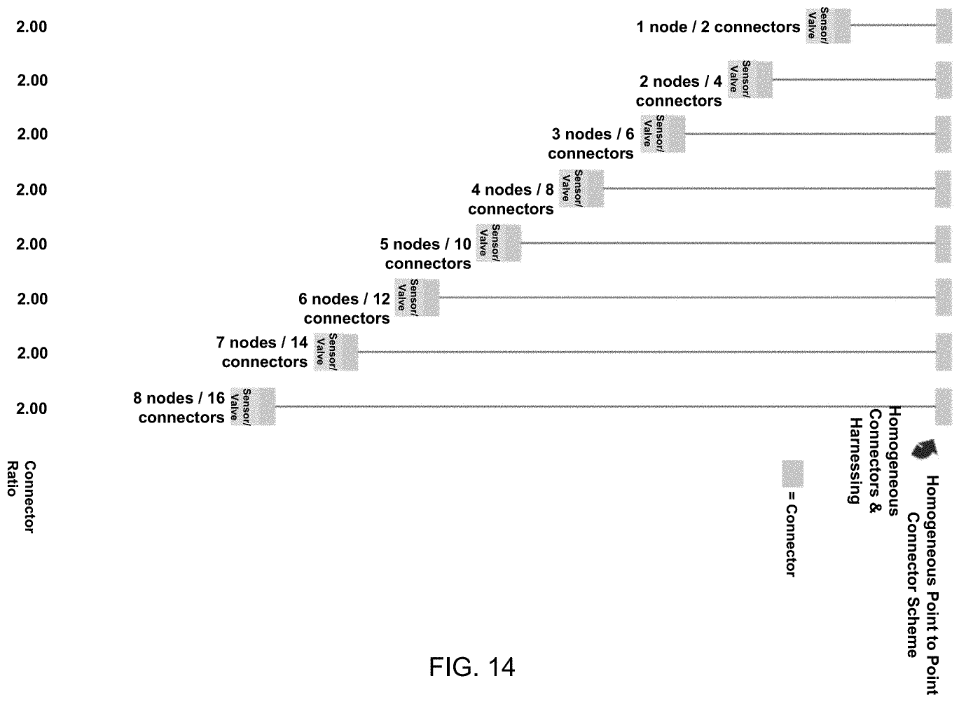

FIG. 14 depicts a conventional “homogeneous” point-to-point bus architecture for which each node (i.e., a connection point for a sensor or actuator) requires a passive T-connector. As used herein, a “homogeneous” point-to-point architecture is a wire harness that comprises a cable for each sensor, e.g., two pairs of wires in a single cable dedicated to each 0-5V sensor in the network, which results in a harness comprising a lot of cables that may differ in length but for which the pinout is almost exactly the same, and where each cable has two connectors. The number of connectors per node (or per sensor or actuator) therefore remains constant in this scenario, with a fixed value of two connectors per sensor or actuator (as indicated in the left-hand column) included in the harness system.

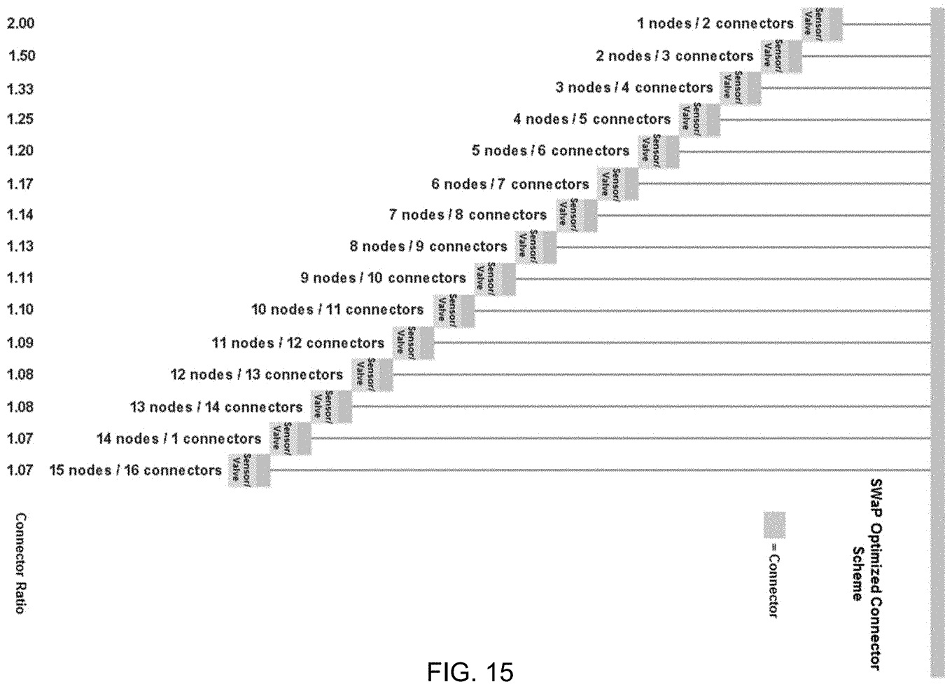

FIG. 15 depicts a conventional single origin point-to-point architecture for which the average number of connectors required per node (or per sensor or actuator, for those comprising connectors) asymptotically approaches a value of one (left-hand column) as the number of nodes included in the wire harness system is increased. The latter approach minimizes the total connector count for the wire harness but at the expense of having to use a custom wire harness that is not easily reconfigured. There will always be the “central” or “upstream” single connector that all downstream sensors/actuators emanate from, and therefore the number of connectors will be the number of sensors/actuators+1.

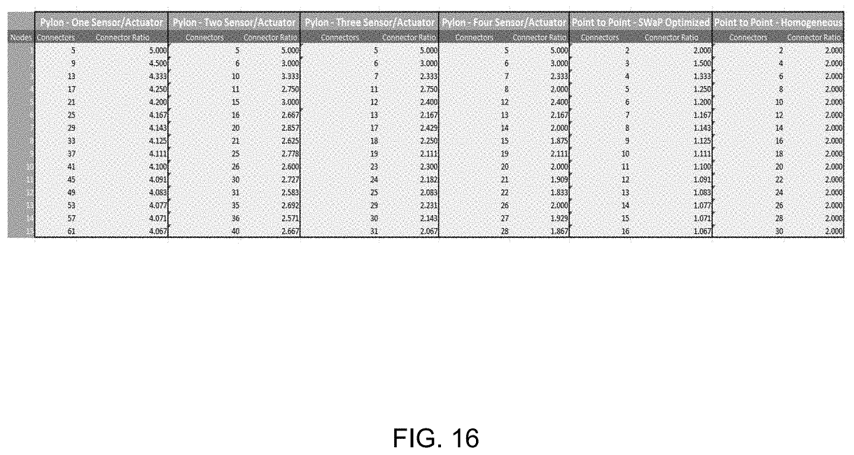

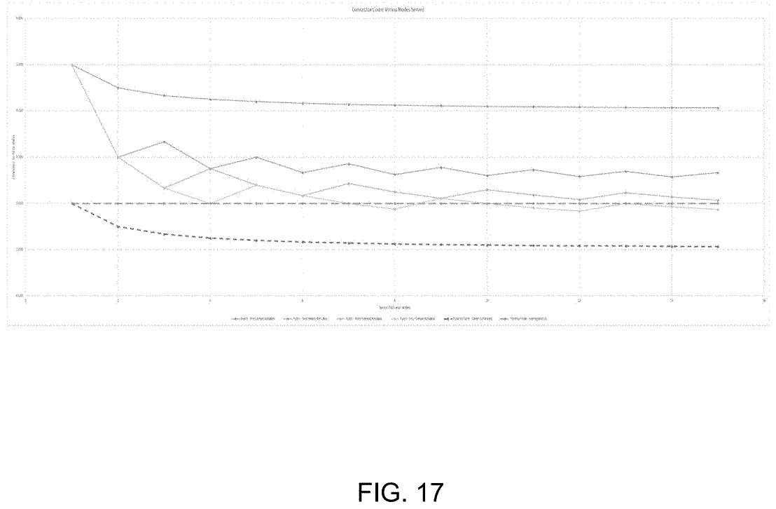

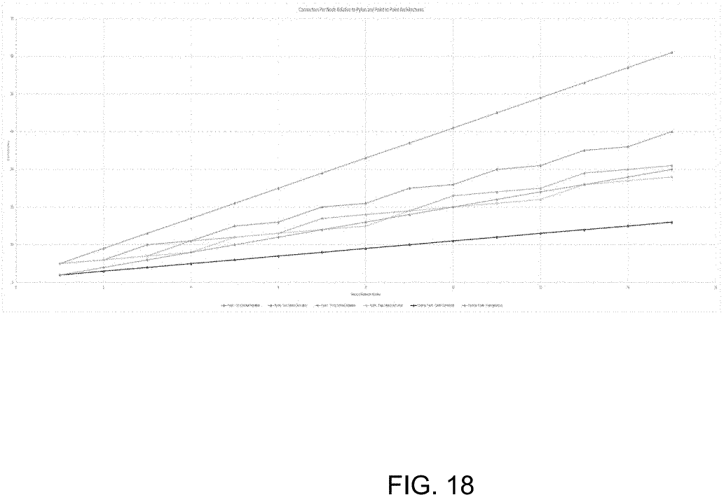

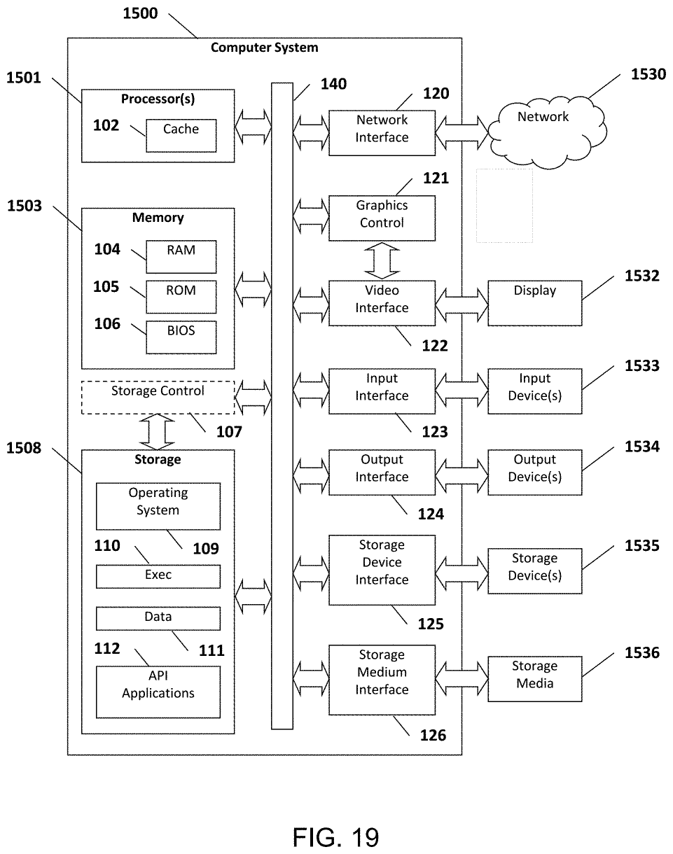

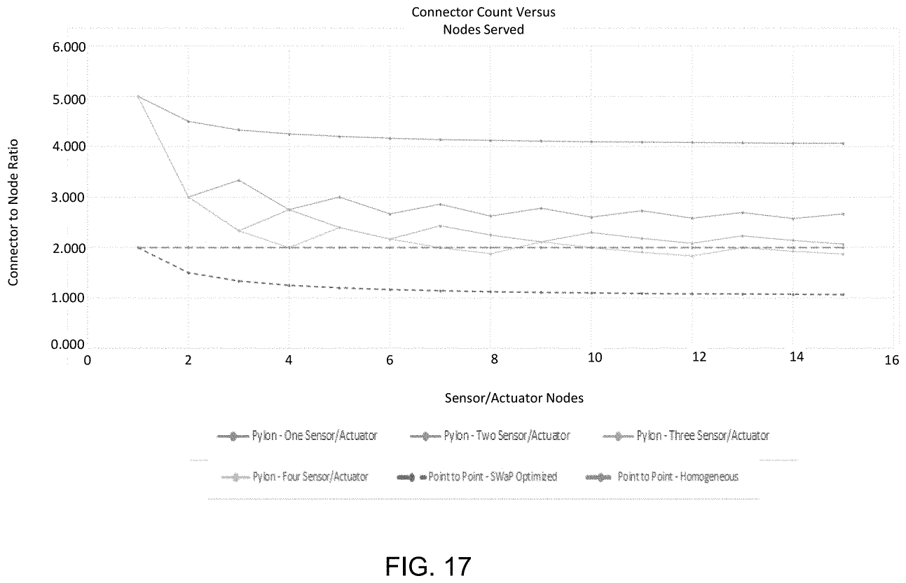

FIG. 16 provides a table that summarizes the number of connectors required and the average connector-to-node ratio as a function of the number of nodes in the wire harness, and a comparison to that for conventional point-to-point bus architectures. These results are plotted in FIG. 17 (solid blue line=1 sensor/actuator per smart node; solid orange line=2 sensors/actuators per smart node; solid gray line=3 sensors/actuators per smart node; solid yellow line=4 sensors/actuators per smart node; dashed green line=2 sensors/actuators per smart node (one upstream and one on sensor, homogeneous point-to-point architecture; dashed blue=SWaP optimized octopus harnessing), and indicate that by supporting three sensors and/or actuators per smart node device (solid gray line), the average connector count per node approaches the two connectors per node average connector count for a conventional point-to-point architecture as the total number of nodes is increase, while supporting more than three nodes per smart node device (e.g., solid yellow line) provides minimal added benefit.

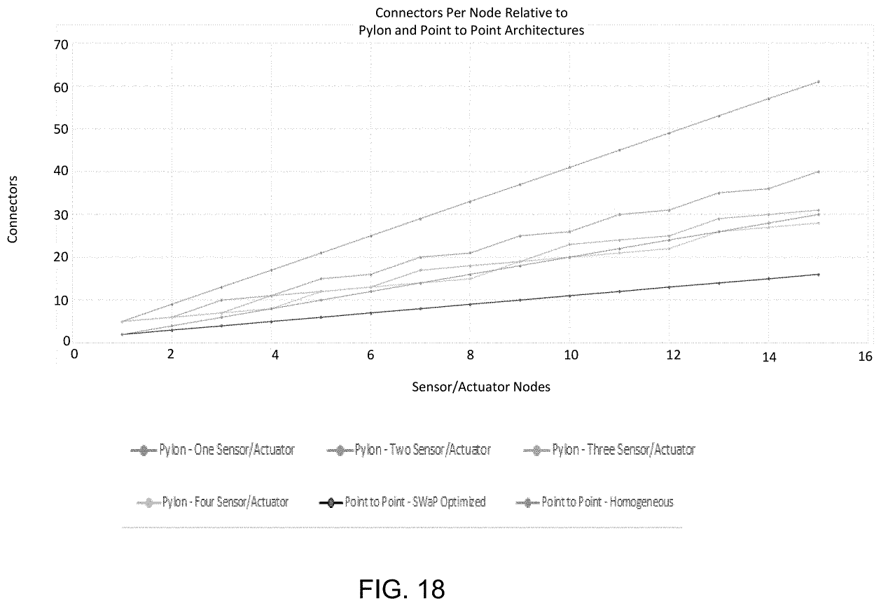

FIG. 18 provides a plot of the total number of connectors required as a function of the number of sensor/actuator nodes in a “smart” wiring harness architecture for different connector-to-node ratios (solid blue line=1 sensor/actuator per smart node; solid orange line=2 sensors/actuators per smart node; solid gray line=3 sensors/actuators per smart node; solid yellow line=4 sensors/actuators per smart node). The plots again illustrate that supporting three sensors and/or actuators per smart node minimizes the total number of connectors required, while supporting more than three sensors and/or actuators per smart node yields minimal additional benefit.

### Computing Systems:

In some aspects of the present disclosure, wire harness systems comprising a plurality of smart node devices may be interfaced with, or part of, a computing system, e.g., a system controller. Referring to FIG. 19, a block diagram is shown depicting an exemplary machine that includes a computer system 1500 (e.g., a processing or computing system) within which a set of instructions can execute for causing a device to perform or execute any one or more of the aspects and/or methodologies for static code scheduling of the present disclosure. The components in FIG. 19 are examples only and do not limit the scope of use or functionality of any hardware, software, embedded logic component, or a combination of two or more such components implementing particular embodiments.

Computer system 1500 may include one or more processors 1501, memory 1503, and storage 1508 that communicate with each other, and with other components, via a bus 140. The bus 140 may also link a display 1532, one or more input devices 1533 (which may, for example, include a keypad, a keyboard, a mouse, a stylus, etc.), one or more output devices 1534, one or more storage devices 1535, and various tangible storage media 1536. All of these elements may interface directly or via one or more interfaces or adaptors to the bus 140. For instance, the various tangible storage media 1536 can interface with the bus 140 via storage medium interface 126. Computer system 1500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1500 includes one or more processor(s) 1501 (e.g., central processing units (CPUs) or general purpose graphics processing units (GPGPUs)) that carry out functions. Processor(s) 1501 optionally contains a cache memory unit 102 for temporary local storage of instructions, data, or computer addresses. Processor(s) 1501 are configured to assist in execution of computer readable instructions. Computer system 1500 may provide functionality for the components depicted in FIG. 19 as a result of the processor(s) 1501 executing non-transitory, processor-executable instructions embodied in one or more tangible computer-readable storage media, such as memory 1503, storage 1508, storage devices 1535, and/or storage medium 1536. The computer-readable media may store software that implements particular embodiments, and processor(s) 1501 may execute the software. Memory 1503 may read the software from one or more other computer-readable media (such as mass storage device(s) 1535, 1536) or from one or more other sources through a suitable interface, such as network interface 120. The software may cause processor(s) 1501 to carry out one or more processes or one or more steps of one or more processes described or illustrated herein. Carrying out such processes or steps may include defining data structures stored in memory 1503 and modifying the data structures as directed by the software.

The memory 1503 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 1501, and RAM 104 may act to communicate data and instructions bidirectionally with processor(s) 1501. ROM 105 and RAM 104 may include any suitable tangible computer-readable media described below. In one example, a basic input/output system 106 (BIOS), including basic routines that help to transfer information between elements within computer system 1500, such as during start-up, may be stored in the memory 1503.

Fixed storage 1508 is connected bi-directionally to processor(s) 1501, optionally through storage control unit 107. Fixed storage 1508 provides additional data storage capacity and may also include any suitable tangible computer-readable media described herein. Storage 1508 may be used to store operating system 109, executable(s) 110, data 111, applications 112 (application programs), and the like. Storage 1508 can also include an optical disk drive, a solid-state memory device (e.g., flash-based systems), or a combination of any of the above. Information in storage 1508 may, in appropriate cases, be incorporated as virtual memory in memory 1503.

In one example, storage device(s) 1535 may be removably interfaced with computer system 1500 (e.g., via an external port connector (not shown)) via a storage device interface 125. Particularly, storage device(s) 1535 and an associated machine-readable medium may provide non-volatile and/or volatile storage of machine-readable instructions, data structures, program modules, and/or other data for the computer system 1500. In one example, software may reside, completely or partially, within a machine-readable medium on storage device(s) 1535. In another example, software may reside, completely or partially, within processor(s) 1501.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1500 may also include an input device 1533. In one example, a user of computer system 1500 may enter commands and/or other information into computer system 1500 via input device(s) 1533. Examples of an input device(s) 1533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1533 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 1500 is connected to network 1530, computer system 1500 may communicate with other devices, specifically mobile devices and enterprise systems, distributed computing systems, cloud storage systems, cloud computing systems, and the like, connected to network 1530. Communications to and from computer system 1500 may be sent through network interface 120. For example, network interface 120 may receive incoming communications (such as requests or responses from other devices) in the form of one or more packets (such as Internet Protocol (IP) packets) from network 1530, and computer system 1500 may store the incoming communications in memory 1503 for processing. Computer system 1500 may similarly store outgoing communications (such as requests or responses to other devices) in the form of one or more packets in memory 1503 and communicated to network 1530 from network interface 120. Processor(s) 1501 may access these communication packets stored in memory 1503 for processing.

Examples of the network interface 120 include, but are not limited to, a network interface card, a modem, and any combination thereof. Examples of a network 1530 or network segment 1530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1530, may employ a wired and/or a wireless mode of communication. In general, any network topology may be used.

Information and data can be displayed through a display 1532. Examples of a display 1532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1532 can interface to the processor(s) 1501, memory 1503, and fixed storage 1508, as well as other devices, such as input device(s) 1533, via the bus 140. The display 1532 is linked to the bus 140 via a video interface 122, and transport of data between the display 1532 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1532, computer system 1500 may include one or more other peripheral output devices 1534 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 1500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium:

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program:

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Standalone Applications:

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules:

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases:

In some embodiments, the platforms, systems, media, and methods disclosed herein include one or more databases, or use of the same. In view of the disclosure provided herein, those of skill in the art will recognize that many databases are suitable for storage and retrieval of, for example, smart node calibration data, sensor calibration data, etc., and other types of information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Smart Node Device and Wire Harness Applications:

Although being developed specifically in the context of aerospace launch vehicles that are fabricated using rapid prototyping and manufacturing technologies (e.g., 3D printing, etc.), the disclosed smart node devices and “smart” wiring harness systems assembled therefrom have potential application in a variety of other vehicle types and industries including, but not limited to, automobiles, conventional aircraft, manned or unmanned aerial vehicles (e.g., drones), artificial satellites, and other aerospace vehicles.

### EXAMPLES

These examples are provided for illustrative purposes only and not intended to limit the scope of the claims provided herein.

### Prophetic Example 1—Rapid Reconfiguration of the Wiring Harness for a 3D-Printed Rocket Engine

As a non-limiting example of the utility of the disclosed smart node devices and smart wiring harness systems, consider a rocket engine being designed and prototyped using a laser sintering process for 3D-printing of metal alloys to fabricate the engine itself. Examples of the advantages conferred using this approach include short turn-around times for implementing design changes, the ability to fabricate engines that comprise a minimal number of individual parts (or only a single part in some instances) thereby minimizing the time required for assembly and eliminating potential assembly errors, and the minimization of waste materials during the fabrication process.

Assume that the initial engine design requires 32 sensors (e.g., temperature sensors, pressure sensors, strain sensors, etc.) for collecting data relating to the performance of the engine, and 15 valves to control (e.g., fuel valves, oxidizer valves, etc.). The sensors and valve actuators are positioned at specified locations around the engine, and communicate with a system controller via a wire harness that transmits power and data.

In a conventional approach to designing an engine wire harness, e.g., using a point-to-point wiring architecture, the locations of each sensor and valve actuator will be taken into account in designing a custom wire harness that accommodates the separation distances between the various sensors and actuators and the system controller, as well as the specific wire gauges required, power requirements, etc. If the engine design is subsequently modified during development and the total number and/or positions of sensors and/or actuators changes, a costly delay may be incurred as the wire harness serving up to all 32 sensors is also modified accordingly. This can also potentially de-mate all sensors, thus increasing risk and labor.

The smart node devices of the present disclosure provide a means for quickly and easily configuring or re-configuring a wire harness system. In some instances, individual smart node devices may control three or more sensors and/or actuators, and their individual locations identified by correlating a unique smart node identification code with a unique position barcode on the engine. Each smart node may be connected to a nearest neighbor smart node to form a network which allows communication between a system controller and each smart node, as well as addressable communication with and control of individual sensors or actuators. The wire harness system may be initially configured by deploying system controller software once the physical connections have been completed that reads the location and calibration data associated with each smart node device and adjusts communication and control parameters accordingly to optimize the performance of the wire harness system. If and when an engine design changes during development, one or more additional smart node devices may be added to the system (or, in some instances, removed from the system) simply by connecting to the nearest smart node device and re-installing the system configuration software. In addition to connecting to the nearest bus, a smaller more localized custom harness may be used to connect the new Pylon to sensors/actuators but none of the other sensors/actuators must be touched or disturbed.

What is claimed is:

1. A smart node device comprising:
a) a microcontroller;
b) an electric power converter; and
c) at least one circuit selected from the group consisting of a sensor interface circuit configured to capture data from at least one sensor, an actuator drive circuit configured to control at least one actuator, or any combination thereof;
wherein the microcontroller is configured for electrical communication with the at least one circuit, with another smart node device, and with a system controller.

2. The smart node device of claim 1, wherein the device further comprises no more than three external connectors.

3. The smart node device of claim 1, wherein the device comprises a sensor interface circuit and is configured to capture data from at least three sensors.

4. The smart node device of claim 1, wherein the device comprises an actuator drive circuit and is configured to control at least three actuators.

5. The smart node device of claim 1, wherein the device comprises a sensor interface circuit that is configured as an interface for a resistance-temperature detector (RTD), thermocouple, or thermistor.

6. The smart node device of claim 1, wherein the device comprises a sensor interface circuit that is configured as an interface for a pressure sensor, a differential pressure sensor, a break-wire (short or open circuit) sensor for payload deployment or connector separation, a resistance sensor, a voltage sensor, or a current sensor.

7. The smart node device of claim 1, wherein the device comprises a sensor interface circuit that is configured as an interface for an optical time-of-flight (ToF) sensor, a thermal image sensor, a CMOS image sensor, or a CCD image sensor.

8. The smart node device of claim 1, wherein the device comprises an actuator drive circuit that is configured to control a valve, a solenoid, a switch, a relay, a light emitting diode (LED), a heater, a pyrotechnic device, a hydraulic actuator, a pneumatic actuator, an electrical actuator, or a motor.

9. The smart node device of claim 1, wherein the electric power converter is a direct current-to-direct current (DC/DC) converter circuit.

10. The smart node device of claim 1, wherein the microcontroller is further configured to provide digital communication with a system controller.

11. The smart node device of claim 10, wherein the microcontroller is configured to communicate a physical location address for the device to the system controller.

12. The smart node device of claim 10, wherein the device comprises a sensor interface circuit and the microcontroller is configured to transmit sensor data between a sensor and the system controller in an individually-addressable fashion.

13. The smart node device of claim 10, wherein the device comprises an actuator drive circuit and the microcontroller is configured to transmit actuator control signals between the system controller and an actuator in an individually-addressable fashion.

14. The smart node device of claim 10, wherein the microcontroller is configured to provide fault detection or overcurrent detection.

15. The smart node device of claim 10, wherein the device further comprises a unique binary identification code that may be used to associate calibration data with the device.

16. A harness system comprising:
a) two or more smart node devices, wherein each smart node device comprises:
i) a microcontroller;
ii) an electric power converter; and
iii) at least one circuit selected from the group consisting of a sensor interface circuit configured to capture data from at least one sensor, an actuator drive circuit configured to control at least one actuator, or any combination thereof;
wherein the microcontroller is configured for electrical communication with the at least one circuit, with another smart node device, and with a system controller; and
b) a system controller.

17. The harness system of claim 16, wherein the harness system is configured for transmitting electrical power, sensor data, and actuator control signals between the system controller and two or more physical locations on an aerospace launch vehicle.

18. The harness system of claim 17, wherein the aerospace launch vehicle comprises 3D-printed engine parts.

19. The harness system of claim 16, wherein the harness system comprises fewer than 3 connectors per node on average, fewer than 2.5 connectors per node on average, fewer than 2.2 connectors per node on average, or fewer than 2.1 connectors per node on average.

20. The harness system of claim 16, wherein the system controller is configured to execute software that automatically re-configures the harness system when a smart node device is added to or removed from the harness system.
